(19) United States
(12) Patent Application Publication
(10) Pub. No.: US 2009/0096140 A1
(43) Pub. Date: Apr. 16, 2009

(54) Gas Spring

(76) Inventors: Takashi Asa, Tokyo (JP); Yasushi Saito, Nagano-ken (JP)

Correspondence Address: Michael L. Crapenhoft;c/o Hiroe & Associates, 4-3, Usa 3-chome, Gifu City, 500-8368, omitted

(21) Appl. No.: 12/250,540

(22) Filed: Oct. 14, 2008

(30) Foreign Application Priority Data
Oct. 15, 2007 (JP) 2007-267317

(51) Int. Cl. F16F 9/18

(52) U.S. Cl. 267/124

(57) ABSTRACT

A stopper member forms a part of a lock mechanism in a gas spring. A rod body has a base end side inserted into a cylinder body, with the rod body movable into and out of the cylinder body and urged in an outward direction with respect to the cylinder body by the pressure of a gas sealed inside the cylinder body. A stopper member receives a head end portion of the cylinder body inside the stopper member. A projecting portion of the stopper member is located on an end face opposite an end portion of the cylinder body. The stopper member can be shifted manually between a first position that allows contraction of the rod body into the cylinder body, and a second position in which such contraction is prevented, thereby locking the gas spring in an extended state.

### BACKGROUND OF THE INVENTION

The present invention relates to a gas spring and particularly to an improved gas spring with a lock function for use at a rear door of a vehicle, for example.

Various proposals have been made for gas springs with lock mechanisms for use at rear doors of vehicles. Japanese Published Patent Application No. 2007-64281, for example, describes a gas spring that has a rod body with a base end side inserted into a cylinder body. The rod body can be moved into and out of the cylinder body, and is urged in a direction outwardly of the cylinder body by the pressure of a gas sealed inside the cylinder body. The gas spring includes a cylindrical cover body into which the rod body is inserted.

The gas spring includes a base end portion on a cover body. The cover body can pivot on a distal end of the rod body, which projects outside of the cylinder body. An end portion of the cover body carries a stopper member that has a head end portion facing the cylinder body.

The end portion of the cover body can move with respect to the base end portion and the rod body, and the stopper member at the end of the cover body can thus move in a direction perpendicular to the diameter of the cylinder body.

The configuration is such that, when the stopper member is in a position in which the cover body is aligned with the rod body, the rod body can then move in and out of the cylinder body, but when the stopper member is moved so that the axis of the cover body is inclined with respect to that of the rod body, the stopper member prevents the rod body from moving into the cylinder body.

Thus, the gas spring disclosed in the Japanese patent application publication can be locked in place by moving the stopper member with respect to the cylinder body. The gas spring will therefore not contract from its extended configuration even if, for example, an unexpected external force such as the wind occurs, and an open vehicle rear door will thus not close unexpectedly.

The gas spring described in the published Japanese patent application provides a reliable locking mechanism. The gas spring may be, however, less than ideal from the standpoint of its manufacture.

Specifically, the gas spring's lock mechanism's stopper member should be fixed firmly at the end of the cover body. If, though, the stopper member rotates with respect to the cover body, it will not perform properly as a part of the lock mechanism.

This is because the lock mechanism's stopper member is press-fit onto the end portion of the cover body, and the reciprocal movement with respect to the cylinder body is enabled by manual operation through a detent structure.

The detent structure includes a pair of projections that hold the cylinder body in place. Passage of the cylinder body between these projections enables movement of the stopper member with respect to the cylinder body.

This means that for the stopper member to be positioned properly at the end portion of the cover body, the pair of projections that make up the detent structure must be aligned properly. Ensuring this requires some effort, which limits the productivity with which the assembly can be made.

The present invention was made in view of this and is intended to provide a gas spring with a lock mechanism in which a stopper member that forms a part of the lock mechanism can be provided at an end portion of the cover body without position displacement, and one that allows for enhanced efficiency in assembly the device.

### SUMMARY OF THE INVENTION

In order to achieve this, a gas spring that embodies the present invention is provided in which a rod body has a base end side inserted into a cylinder body, and in which the rod body moves into and out of the cylinder body. The rod body is urged in a direction outwardly of the cylinder body by the pressure of a gas sealed inside the cylinder body. The gas spring includes a cylindrical cover body with the rod body inserted inside the cover body. A base end portion of the cover body is attached to an end portion of the rod body that projects outside of the cylinder body. An end portion of the cover body carries a stopper member with a head end portion that receives an end of the cylinder body inside the head end portion. When an axis of the cover body is aligned with an axis of the rod body, the rod body can then move into and out of the cylinder body, but when the axis of the rod body is inclined with respect to that of the cylinder body the stopper member prevents the rod body from moving into the cylinder body. The stopper member is formed substantially cylindrically with an axial direction that is substantially the same as that of the cover body and with a projecting portion that projects some distance in the axial direction of the stopper member at an end face that opposes a bottom end portion of the cylinder body.

Thus, in the gas spring described herein, since the stopper member of the lock mechanism has a projecting portion, the stopper member can be aligned in a rotational direction with respect to the cover body by aligning the projecting portion as a reference. Since the projecting portion is formed on the stopper member on the end face that opposes the bottom end portion of the cylinder body, a jig can be applied to the projecting portion when the device is assembled. This makes fixing the stopper member onto the cover body in the specified direction easier.

### BRIEF DESCRIPTION OF THE DRAWINGS

An exemplary embodiment of the present invention will be described below with reference to the appended figures, in which:

FIG. 1 is a partial cross-sectional view of the gas spring according to one embodiment;

FIGS. 2(a) and 2(b) illustrate operation states of the stopper member;

FIGS. 3(a) and 3(b) illustrate operation states of the stopper member, as viewed in cross section x-x along section lines x-x in FIGS. 2(a) and 2(b); of the stopper member in FIGS. 2(a) and 2(b); and

FIG. 4 is a side view of the gas spring according to one embodiment.

### DETAILED DESCRIPTION OF PREFERRED EMBODIMENTS

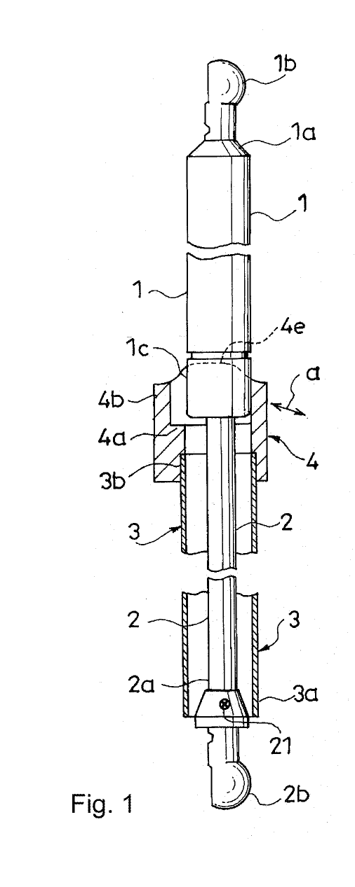

The present invention will be described below in connection with a preferred embodiment. The a gas spring shown in FIG. 1 is similar to most gas springs of this type in that a rod body 2 with a base end side (the upper side in FIG. 1) is inserted into and movable in and out of a cylinder body 1. The rod body 2 is urged in a direction outwardly of the inside of the cylinder body 1 by the pressure of a gas sealed inside the cylinder body, i.e., in a direction that tends to lengthen the gas spring.

This gas spring includes a socket 2b that forms a part of a ball joint at a distal end portion 2a (toward the lower side of the figure) of the rod body 2 that projects from inside the cylinder body 1. A similar socket 1b that forms a part of a second ball joint is located at an end portion 1a (at the upper side of the figure) of the cylinder body 1.

The gas spring has a lock mechanism. A cylindrical cover body 3 includes a base end portion 3a (toward the lower side of the figure) that is connected to the distal end portion 2a of the rod body 2, which projects outside of the cylinder body 1. The cover body 3 further includes an end portion 3b (an upper end portion in the figure), which is located adjacent a head end portion 1c of the cylinder body 1.

As shown in the figure, the cover body 3 includes the base end portion 3a and is pivotally attached to the distal end portion 2a of the rod body 2 by a pin 21. The end portion 3b is movable back and forth in the directions indicated by arrow a, that is, in a forward direction of movement toward the right side of the figure and in a reversed, backward direction of movement that returns the end portion to its original position.

A stopper member 4 is located at the end portion 3b of the cover body 3. The stopper member 4 is substantially cylindrical, and substantially coaxial with the cover body 3. The stopper member 4 receives the head end portion 1c of the cylinder body 1 inside the stopper member 4.

The stopper member 4 is made of a synthetic resin material so that metal-to-metal contact with the cylinder body 1 is avoided, so that the overall weight of the gas spring is reduced, and so that the gas spring can be manufactured economically.

Since the cover body 3 is can move back and forth as mentioned above, the stopper member 4 is can accordingly be moved by hand in a direction perpendicular to the diameter of the cylinder body 1.

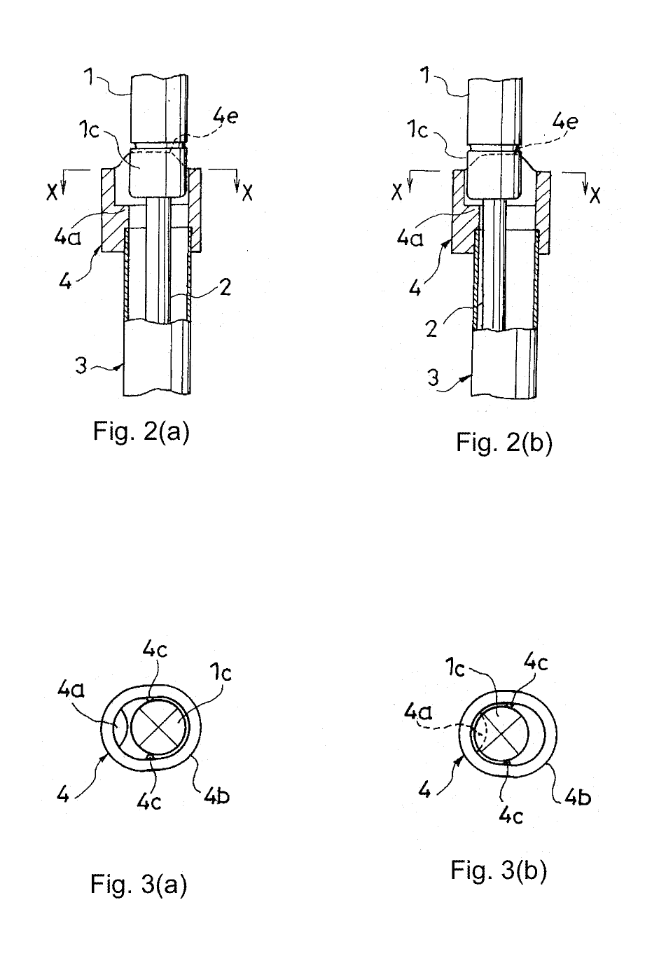

If no external manual force is applied to the stopper member 4, the axis of the cover body 3 stays aligned with the axis of the rod body 2 as shown in FIG. 1 and FIG. 2(a).

Therefore, as is also shown in FIG. 3(a), a lock portion 4a of the stopper member 4 is not opposed against the head end portion 1c of the cylinder body 1. This configuration allows the gas spring to expand and contract as the rod body 2 moves in and out of the cylinder body 1.

If, though, the stopper member 4 is moved manually forward with respect to the diameter of the cylinder body 1 as shown in FIG. 2(b), the axis of the cover body 3 is inclined with respect to the axis of the rod body 2.

As shown in FIG. 3(b), therefore, the lock portion 4a of the stopper member 4 is opposed to the head end portion 1c of the cylinder body 1, which prevents contraction of the gas spring by stopping the movement of the rod body 2 into the cylinder body 1.

The stopper member 4 is thus operable to allow or prevent movement with respect to the cylinder body 1.

Specifically, as shown in FIGS. 3(a) and 3(b), the stopper member 4 has a projections 4c that form a detent structure on an inner circumference of the main body portion 4b, which holds the head end portion 1c of the cylinder body 1 inside it.

Each of the projections 4c is, although not shown in detail, in the form of a rib with a length substantially equal to the length of the main body portion 4b in the axial direction. A pair of these projections 4c sandwiches the cylinder body 1 in a direction of the cylinder body's diameter.

The projections 4c are formed as elongated ribs for durability, that is, resistance to abrasion, as compared to a configuration in which the projections 4c are formed only at points. Therefore, as long as the abrasion resistance is adequately maintained, the projections may be made not as ribs, but instead in the shape of pins, points, or dots.

The distance between the distal ends of the pair of projections 4c is slightly smaller than the inner diameter of the head end portion 1c of the cylinder body 1. Thus, when the head end portion 1c of the cylinder body 1 passes between the projections 4c, a large external force is required to make this movement. In other words, the head end portion 1c of the cylinder body 1 cannot simply move freely inside the main body portion 4b of the stopper member 4 unless a large external force is applied.

As a result, in the stopper member 4, a manually applied external force enables movement in the diameter direction of the cylinder body 1 and also enables a stop at the reciprocal movement position.

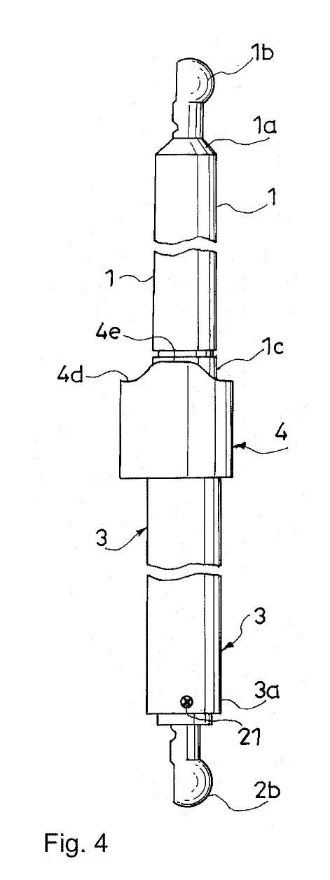

On the other hand, in the gas spring described here, the stopper member 4 is formed substantially cylindrically with the same axial direction as that of the cover body 3 as mentioned above, and the stopper member 4 has, as shown in FIG. 4, a projecting portion that projects some distance in the axial direction of the stopper member 4 on an end face 4d that opposes the bottom end portion 1a of the cylinder body 1.

The projecting portion is, as shown in the figure, formed as a projection portion 4e that projects from the above-mentioned end face 4d of the stopper member 4, and formed as a pair holding the head end portion 1c of the cylinder body 1 from its upper and lower parts.

That is, the projecting portion is formed on the end face 4d that opposes the bottom end portion 1c of the cylinder body 1 at both face portions along the reciprocal movement direction (see the arrow a in both directions in FIG. 1) in the stopper member 4 with respect to the cylinder body 1.

Thus, in the configuration described here, since the stopper member 4 of the lock mechanism has a projection portion 4e, using the projection portion 4e as a reference, the stopper member 4 can be positioned conveniently as desired in the rotational direction with respect to the cover body 3.

The projection portion 43 of the stopper member 4 is formed on the end face 4d that opposes the bottom end portion 1c of the cylinder body 1. Thus, when the gas spring is mechanically assembled using a jig, the jig can be linked with the projection portion 4e, for example, which facilitates the work of providing the stopper member 4 on the cover body 3 in the desired direction.

As mentioned above, the projection portion serves as a positional reference. As long as it can be linked with a jig, it does not have to be in the form of the projection portion 4e as shown; it may instead be formed as a recess, for example, or not as a pair but instead as a single member.

In the gas spring described here, however, since the stopper member 4 has the projection 4c that forms the detent structure, the projecting portion is preferably in the form of the projection portion 4e, and not in the form of a recess. It is better made as a pair, moreover, because the projection 4c is thus formed more easily.

Providing the projection portion 4e on the stopper member 4 at the end face 4d that opposes the bottom end portion 1a of the cylinder body 1 also increases the area of the stopper member 4. This accordingly increases the ease with which the stopper member can be gripped with fingers, which allows the stopper member 4 to be moved more easily by manual operation, thereby improving operating performance of the device.

What is claimed is:

1. A gas spring in which a rod body has a base end side inserted into and movable into and out of a cylinder body, wherein the rod body is urged in a direction outwardly of the cylinder body by pressure of a gas sealed inside the cylinder body, wherein a cylindrical cover body has the rod body inserted in the cylinder body, wherein a base end portion of the cover body is pivotally attached to a distal end portion of the rod body that projects of outside the cylinder body, wherein the an end portion of the cover body has a stopper member that receives a head end portion of the cylinder body inside the stopper member, wherein when an axis of the cover body is aligned with an axis of the rod body, the rod body is allowed to move into and out of the cylinder body, but when the axis of the cover body is inclined with respect to the axis of the rod body, the stopper member prevents movement of the rod body into the cylinder body, wherein the stopper member is formed substantially cylindrically with the same axial direction as that of the cover body, and wherein the stopper member has a projecting portion formed in the axial direction of the stopper member on an end face that opposes a bottom end portion of the cylinder body.

2. The gas spring according to claim 1, wherein the projecting portion is in the form of a projection portion that projects from the end face opposing the bottom end portion of the cylinder body in the stopper member.

3. The gas spring according to claim 1 or 2, wherein the projecting portion is formed on the end face opposing the bottom end portion in the cylinder body on one face portion or both face portions along a reciprocal movement direction in the stopper member with respect to the cylinder body.
